(19) United States
(12) Patent Application Publication
(10) Pub. No.: US 2023/0247513 A1
(43) Pub. Date: Aug. 3, 2023

(54) TECHNIQUES FOR CONDITIONAL HANDOVER OF REMOTE AND RELAY USER EQUIPMENTS

(71) Applicant: QUALCOMM Incorporated, San Diego, CA (US)

(72) Inventors: Karthika PALADUGU, San Diego, CA (US); Gavin Bernard HORN, La Jolla, CA (US); Hong CHENG, Basking Ridge, NJ (US); Ozcan OZTURK, San Diego, CA (US); Peng CHENG, Beijing (CN)

(21) Appl. No.: 18/007,989

(22) PCT Filed: Jul. 9, 2020
(86) PCT No.: PCT/CN2020/101028

§ 371 Date: Dec. 2, 2022

(51) Int. Cl. H04W 36/36; H04W 36/00; H04W 36/30

(52) U.S. Cl. CPC H04W 36/362; H04W 36/033; H04W 36/30

(57) ABSTRACT

Aspects of the present disclosure provide techniques for configuring and triggering conditional handover for UE mobility between a direct connection to the base station (Uu connection) and/or a relay connection (PC5 connection). Specifically, the conditional handover configuration may include preparing multiple candidate relay UEs for handover (e.g., from Uu connection to PC5 connection) and conditional handover execution criteria for relay selection (or reselection) for the UE. Similarly, features of the present disclosure provide techniques for conditional handover transition from a PC5 connection back to Uu connection when conditional handover execution criteria are met (e.g., sidelink signal strength between the two UEs falls below a channel condition threshold). Additionally, the techniques provided herein support for conditional handover of the relay UEs from a first base station to a second station while the relay UE is further supporting one or more remote UEs.

### TECHNICAL FIELD

The present disclosure relates to wireless communication systems, and more particularly, to techniques for conditional handover of remote and relay user equipments (UEs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (TDMA) systems, orthogonal frequency division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

### SUMMARY

Aspects of the present disclosure provide techniques for configuring and triggering conditional handover for UE mobility between a direct connection to the base station (Uu connection) and/or a relay connection (PC5 connection). Specifically, the conditional handover configuration may include preparing multiple candidate relay UEs for handover (e.g., from Uu connection to PC5 connection) and conditional handover execution criteria for relay selection (or reselection) for the UE. Similarly, features of the present disclosure provide techniques for conditional handover transition from a PC5 connection back to Uu connection when conditional handover execution criteria are met (e.g., sidelink signal strength between the two UEs falls below a channel condition threshold). Additionally, the techniques provided herein support for conditional handover of the relay UEs from a first base station to a second station while the relay UE is further supporting one or more remote UEs.

In one example, a method, apparatus, and non-transitory computer readable medium for wireless communication are disclosed, The method may include receiving, at a first user equipment (UE), a conditional handover configuration information from a source base station, wherein the conditional handover configuration information, in part, includes conditional handover execution criteria that should be met by the first UE in order to execute a conditional handover. The method may further include determining, at the first UE, that that the conditional handover execution criteria are satisfied based in part on one of channel conditions between the first UE and the source base station falling below a channel condition threshold or a sidelink channel condition between the first UE and a second UE falling below a sidelink channel condition threshold. The method may further include triggering the conditional handover at the first UE to transition communication from the source base station to a target base station either via direct communication path or a relay path.

In another example, another method, apparatus, and non-transitory computer readable medium for wireless communication is disclosed. The method may include receiving, at a source base station, a measurement report from a first user equipment (UE), wherein the measurement report indicates signal quality between the first UE and the source base station. The method may further include identifying one or more candidate target base stations for the first LIE to transition communication towards from the source base station, wherein the one or more candidate target base stations prepare a plurality of relay UEs for the first UE that are in a coverage area of the one or more candidate target base stations. The method may further include generating conditional handover configuration information for the first UE based in part on identifying the one or more candidate target base stations, wherein the conditional handover configuration information in part includes conditional handover execution criteria that should be met by the first UE in order to execute conditional handover. The method may further include transmitting the conditional handover configuration information to the first UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communications system in accordance with aspects of the present disclosure;

FIG. 2 is a schematic diagram illustrating an example of relay communications between a remote UE and a base station via a relay UE in accordance with aspects of the present disclosure;

FIG. 3 is a diagram illustrating an example of wireless relay communication between a relay UE, remote UEs, and base stations in accordance with aspects of the present disclosure;

FIG. 4 is a diagram illustrating an example of the remote UE that may switch communication from direct base station to a relay communication via the relay UE accordance with aspects of the present disclosure;

FIG. 5A is a flow diagram illustrating an example communication flow of a preparation of conditional handover between Uu plane and PC5 (and vice versa) in accordance with aspects of the present disclosure;

FIG. 5B is a flow diagram illustrating an example communication flow of a triggering conditional handover between Uu plane and PC5 (and vice versa) in accordance with aspects of the present disclosure;

FIG. 6 is a flow diagram illustrating an example communication flow of a relay UE mobility that triggers conditional handover) in accordance with aspects of the present disclosure;

FIG. 7 is a schematic diagram of an example implementation of various components of a user equipment in accordance with various aspects of the present disclosure;

FIG. 8 is a flow diagram of an example of a method of wireless communication implemented by the UE in accordance with aspects of the present disclosure;

FIG. 9 is a schematic diagram of an example implementation of various components of a base station in accordance with various aspects of the present disclosure; and

FIG. 10 is a flow diagram of an example of a method of wireless communication implemented by the base station in accordance with aspects of the present disclosure.

An Appendix is attached and includes additional drawings and description.

### DETAILED DESCRIPTION

In recent years, with the introduction of a myriad of smart handheld devices, user demands for mobile broadband has increased. For example, the growth of bandwidth-hungry applications such as video streaming and multimedia file sharing are pushing the limits of current cellular systems. Current cellular systems generally rely on base stations to support wireless communication for a plurality of user equipments (UEs) in a particular coverage area. Thus, each of the base stations may provide communication coverage for a respective geographic coverage area and there may be overlapping geographic coverage areas. As such, while the UE is within a coverage area of a base station, the UE may maintain direct communication with the base station over a Un path or connection. However, UEs typically move around from the coverage area of one base station to another. Thus, as the UE transitions from the coverage area of the first base station to the second base station, the UE and/or the base station may initiate handover procedure to enable seamless connections for the UE.

However, in some scenarios, the UE may also move out of the coverage area of the base station into an area that is not covered by any base station. One solution to address this issue is reliance on functionalities for direct UE to UE communication (which may also be referred to as device-to-device (D2D) or sidelink communication), which allows two nearby devices (e.g., UEs) to communicate with each other in the cellular bandwidth without base station involvement or with limited base station involvement. As such, a UE that is outside the coverage area of any base station (e.g., remote UE) may access the network via a relay UE that is within the coverage area of the base station. In other words, the relay UE may act as an intermediary between the base station and the remote UE. The relay UE and the remote UE may communicate over sidelink communication (referred to as PC5 connection). Even still, there are technical challenges with this approach in current systems. Particularly, traditional systems do not provide a mechanism for the UE.s (e.g., remote UE or relay UE) to readily transition between the Uu connection (e.g., direct connection between the UE and the base station) and the PC5 connection (e.g., sidelink communication between remote UE and relay UE).

Aspects of the present disclosure provide techniques for configuring and triggering a conditional handover for UE mobility between a direct connection to the base station (Uu connection) and/or a relay connection (PC5 connection). Specifically, the conditional handover configuration may include preparing multiple candidate relay UEs for handover (e.g., from Uu connection to PC5 connection) and conditional handover execution criteria for relay selection (or reselection) for the LIE. Similarly, features of the present disclosure provide techniques for conditional handover transitions from a PC5 connection hack to Uu connection when conditional handover execution criteria are met (e.g., sidelink signal strength between the two UEs falls below a channel condition threshold). Additionally, the techniques provided herein support for conditional handover of the relay UEs from a first base station to a second station while the relay UE is further supporting one or more remote UEs.

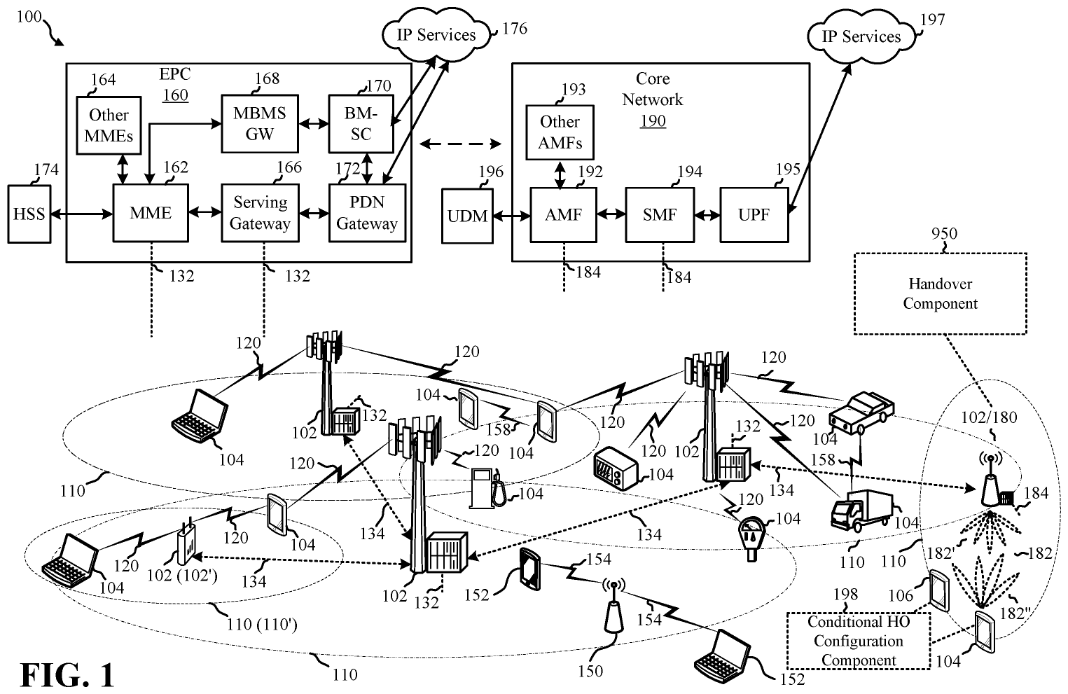

Various aspects are now described in more detail with reference to the FIGS. 1-10. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein.

In some examples, the one or more UEs may be connected directly to the base station over a Uu connection or via a relay UE over a PC5 connection. Particularly, the first connection, between a UE (hereinafter “remote UE”) and an infrastructure node (e.g., gNB) of a network entity, may be called a Uu connection or via a Uu path. The remote UE in Uu connection may use a regular cellular mode, for example, via a base station, to access network resources. For example, the remote UE may communicate with the network entity using the Uu connection through a serving base station by means of regular cellular links.

The second connection, between the remote UE and another UE (hereinafter the “relay UE”), may be called a PC5 connection or via a PC5 path. The PC5 connection is a D2D connection that may take advantage of the comparative proximity between the remote UE and the relay UE (e.g., when the remote OF is closer to the relay UE than to the closest base station). The relay UE may further connect to an infrastructure node (e.g., gNB) via a Uu connection and relay the Uu connection to the remote UE through the PC5 connection. The present disclosure provides various examples to illustrate when and how to switch the remote UE from one connection (the Uu connection or the PC5 connection) to the other for enabling the remote UE to have the most effective and/or efficient connection with the network or the relay UE.

Absent the PC5 connection, the remote UE may connect to the relay UE through the common network that both the remote UE and the relay UE are in communication with. But when the remote UE can efficiently communicate with the relay UE via a sidelink (e.g., V2X), the remote UE may gain capacity, increase throughput, have less latency, and/or increase reliability using the sidelink without the network. In other situations, the remote UE may prefer to connect to the network via the relay UE when such indirect connection improves the communication performance. In this disclosure, the change between the Uu connection (i.e., direct connection with a network) and the PC5 connection (i.e., direct connection with another UE, or the relay UE) may be called relay mobility, switch, or handover. Aspects of the present disclosure pertains to (1) when such relay mobility should be triggered, (2) upon trigger, how each of the remote UE, the relay UE, and the network should operate during the switch procedure; and (3) upon completion, how each of the remote UE, the relay UE, and the network should operate.

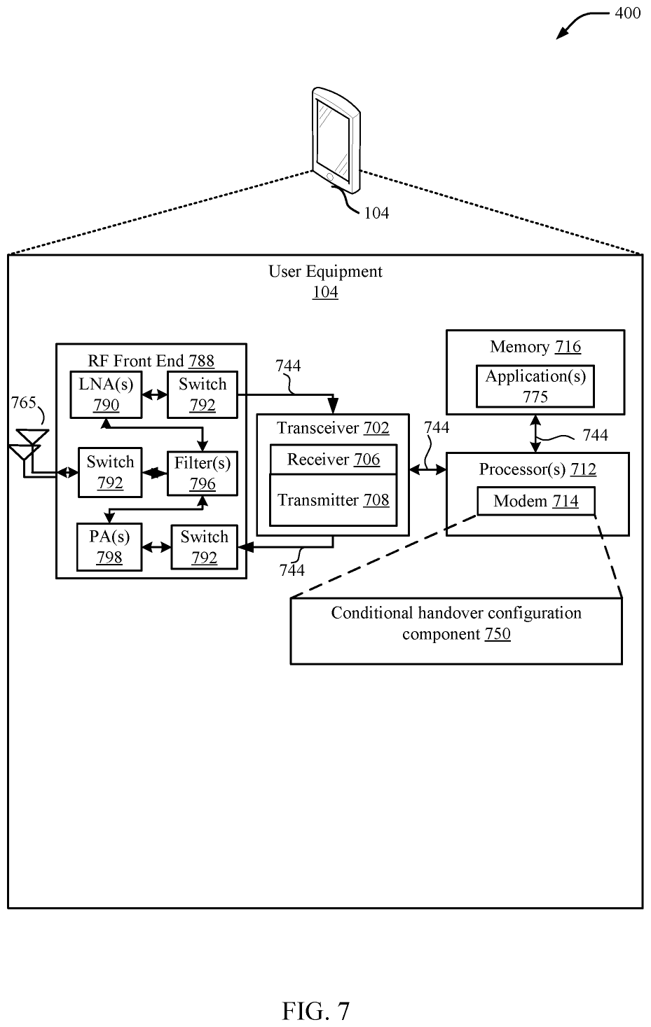

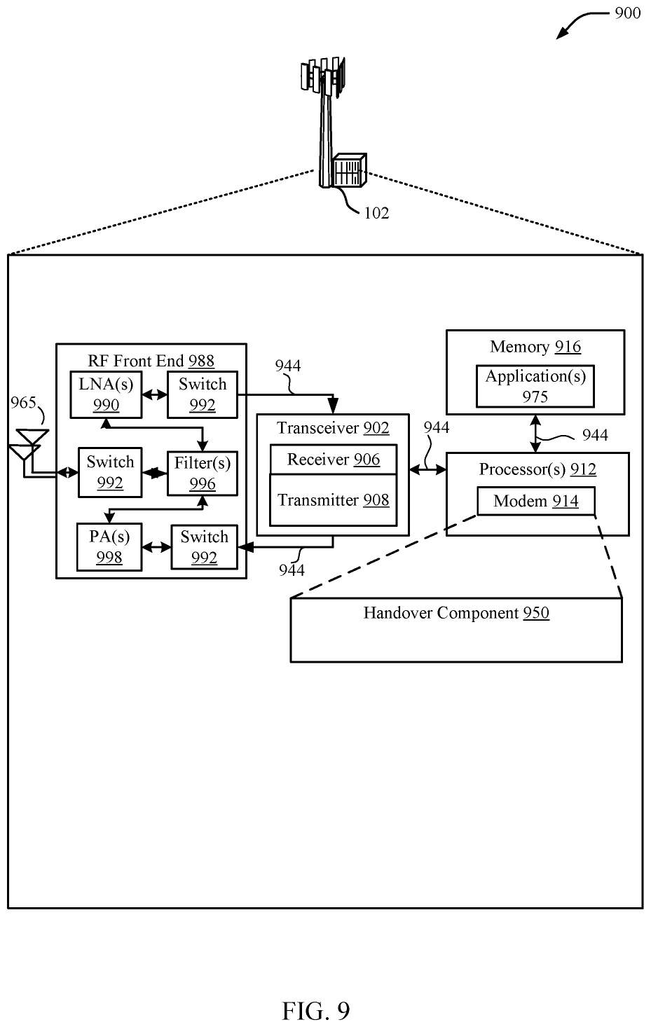

In certain aspects, the UE 104 (e.g., a remote UE) and the UE 106 (e.g., a relay UE) may include a conditional handover configuration component 750 (see FIG. 7) configured to handle data transmission during a handover procedure, such as relaying data transmissions for during a handover procedure. The conditional handover configuration component 750 may also trigger the handover process based on determining that one or more conditional handover criteria are met. In certain aspects, the base station may include a handover component 950 (see FIG. 9) configured to configure and initiate the conditional handover procedure to move the UE 104 and the UE 106 to another base station (and vice versa). For example, the handover component 950 may receive one or more measurement reports from the UE 104 and/or UE 106, and may determine whether to configure the UEs for a conditional handover procedure, including the conditional handover execution criteria, based at least in part on one or more of the measurement reports. The handover component 950 may also prepare one or more relay UEs in response to the conditional handover configuration.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies, Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beam forming 182 with the UE 110 to compensate for the path loss arid short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides hearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

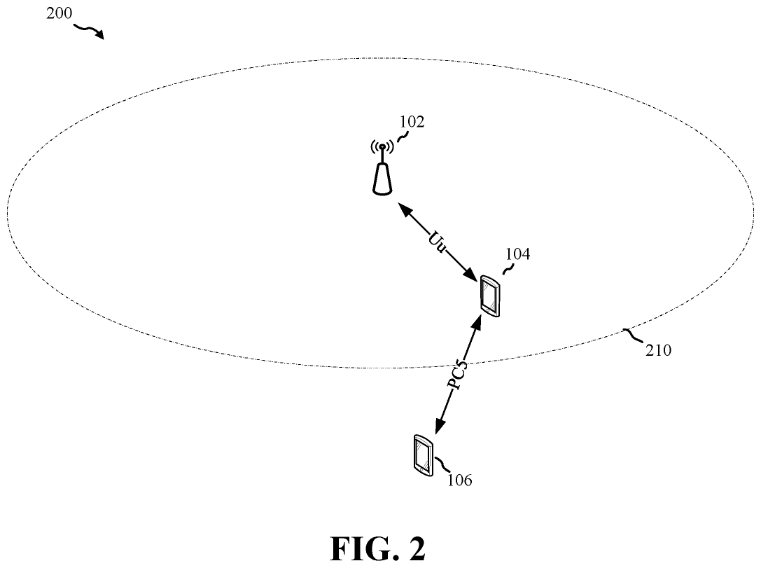

FIG. 2 is a schematic diagram 200 illustrating an example of relay communications between a remote UE 106 and a base station 102 via a relay UE 104. It should be appreciated that in some examples, the hardware capabilities of both the relay UE 104 and the remote UE 106 may be the same.

The base station 102 may provide communication coverage for a geographic coverage area 210. As shown, a relay UE 104 may be within the coverage area 210 of a base station 102. In this scenario, the remote UE 106, however, may be outside the coverage area 210 of the base station 102. As such, the remote UE 106 may request relay services from the relay UE 104 when the remote UE 106 either is unable to establish a direct connection with the base station 102 and/or the direct connection with the base station 102 is degraded (e.g., the remote UE 106 moves out of the coverage area 210 of the base station 102). For example, there may be atmospheric and environmental interference between the remote UE 106 and the base station 102 where the remote UE 106 may need to transmit or receive data through the relay UE 104.

A relay UE (e.g., 104) may monitor for relay requests from other UEs (e.g., 106). For example, the relay UE 104 may be configured to listen for/attempt to detect relay request(s) from nearby UE(s) during monitoring occasions. In some examples, to enable identification, the relay UC 104 may announce its presence by transmitting sidelink discovery messages periodically, and/or the remote UE 106 may announce sidelink relay solicitation messages periodically. The message, which indicates a request for a relay to the base station 102, may be referred to as a relay request, a relay solicitation, or other name. The sidelink discovery message may indicate the relay UE 104 capability to act as a relay and/or may indicate the relay UE's 104 sidelink communication capabilities. During this process, the remote UE 106 may obtain the UE identification (ID) of the relay UE 104 to be used for sidelink transmission and/or reception of the relayed traffic. In some examples, the indication of the relay UE's 104 presence as a potential relay may be sent after the remote UE's 106 request for a relay. The relay UE 104 may indicate its availability to operate as a relay between the remote UE 106 and the base station 102 in response to receiving the request from the remote UE. The message may be a broadcast indication that is broadcast aver sidelink or may be a unicast message that is transmitted to the remote UE over sidelink.

After the transmission of the discovery message or the receipt of the relay solicitation, a communication (e.g., PC5 connection) may be established between the relay UE 104 and the remote UE 106. The remote UE 106 may also communicate with the relay UE 104 to perform a mutual authentication (e.g., direct security mode) procedure. In some examples, PC5 signaling protocol may be used for direct connection management functions such as direct link setup/release, security parameter control, and IP address allocation. In some examples, the remote UE 106 and the relay UE 104 may negotiate for the relaying of communications between the remote UE and the base station.

After the remote UE 106 and the relay UE 104 have discovered each other, the remote UE 106 may be configured to send a message informing the base station 102 about the potential relay UE 104. The message may indicate the presence and/or the availability of the relay UE 104. The remote UE 106 may send one or more measurement reports informing the detected relay UE and/or a sidelink measurement report for the relay UE 106 to the base station 102. The sidelink measurement report may correspond to a measured channel quality (e.g., sidelink-reference signal receive power (RSRP)) between the remote UE 106 and the relay UE 104. The sidelink measurement report may also include an explicit or implicit relay UE identifier. Based on the message and/or the sidelink measurement report, the base station 102 may perform relay UE selection to determine whether the relay UE 104 has met the threshold for being a relay UE 104 and/or whether the relay UE 104 is a suitable or best candidate for relay as there may be multiple candidates (e.g., multiple relay UEs). The base station 102 may determine whether the relay UE 104 qualifies to provide relay services and/or select the relay UE 104 to provide relay services based on the measured channel quality (e.g., an RSRP measurement).

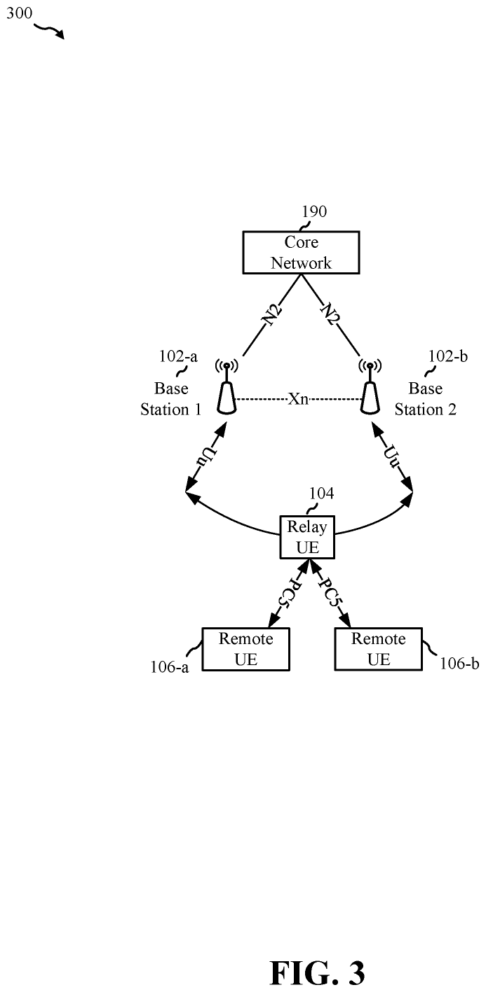

FIG. 3 is a diagram 300 illustrating an example of wireless relay communication between a relay UE 104 and remote UEs (e.g., first remote UE 106-a and second remote UE 106-b), and base stations 102-a, 102-b. The first remote UE 106-a and the second remote UE 10-b may be connected to the relay UE 104, such as via a PC5 interface or a sidelink. The relay UE 104 may further be communicatively coupled with one of a plurality of base stations (e.g., base station 102-a or 102-b) via a Uu interface. The base stations 102-a and 102-b may further be communicatively coupled with a core network 190 (e.g., 5G Core Network) via a N2 interface. The term “radio access” may be used to refer to the Uu interface. The base stations (e.g., 102-a and 102-b) may also communicate with each other using an Xn interface. Thus, the first remote UE 102-a and the second remote UE 102-b may have access to the core network 190 through the relay UE. 104. For example, the first remote UE 106-a may send data to the core network 190 by first transmitting the data to the relay UE 104 via a PC5 interface, and the relay UE 104 may forward the data to the base station 102 (e.g., first base station 102-a or second base station 102-b) via a Uu interface. The base station 102 may then send the data to the core network 190 via the N2 link. Similarly, the second remote UE 106-b may receive a data from the core network 190, where the core network 190 may first forward the data to the relay UE 104 through the base station 102-a and/or 102-b, and the relay LIE 104 may then forward the data to the second remote UE 106-b.

There may be one or more type of architecture, implementation and/or design for the relay UE (e.g., 104), such as a layer 2 (L2) relay and/or a layer 3 (L3) relay, etc. For the L3 relay, a remote UE 106 may communicatively couple with the relay UE 104 through a PC5 interface, where the control plane in the PC5 interface may include one or more of radio resource control (RRC) layer, packet data convergence protocol (PDCP) layer, radio link control (RLC) layer, a medium access control (MAC) layers, and the physical layer. A PC5 unicast link may be configured for the relay UE 104 to serve the remote UEs 106-a, 106-b. In some examples, the remote UE 106 may not have a Uu access stratum (AS) connection with a radio access network (RAN) over the relay path, and may not have a direct non-access stratum (NAS) connection with a core network (e.g., 5G Core Network). Thus, the remote UE 106-a may not be visible to the core network 190. However, the remote LIE 106 may report its presence to the core network 190 by a relay (e.g., through relay UE 104). The remote UE 106 may also make itself known to the core network through a Non-3GPP Interworking (N3IWF),

In L2 UE-to-NW relay, the remote LIE 106 may include a PC5 control plane (e.g., interface) and a Uu control plane. The PC5 control plane may be used for configuring a PC5 unicast link between the remote UE 106 and the relay UE 104 prior to relaying. The remote UE 106 may support Uu AS and non-access stratum (NAS) connections e.g., above PC5 RLC), where a RAN may control the remote UE's PC5 link via an RRC. For example, the NAS and AS messages, such as RRC signaling messages or messages generated by the remote UE 106, may be sent to the PC5 layer and go through the relay UE 104. The control plane protocol stack may include an adaptation layer to support multiplexing multiple UEs' traffic on the relay UE's Uu link. For example, the adaptation layer of the relay UE 104 may handle and identify data packets that are to be sent or relayed to the base station 102.

In some scenarios, one or both of the relay unit 104 and/or the remote UEs 106 may move out of the coverage area of the one or more base stations 102. For example, as illustrated in FIG. 3, the relay UE 104 may move out of the coverage area of the first base station 102-a (or “source base station”) to the coverage area of the second base station 102-b. However, during this transition, the relay UE 104 may support relay communications for one or more remote UEs 106.

The relay UE 104 may trigger a mobility switch from the first base station 102-a to the second base station 102-b based on one or more channel measurements. For example, the mobility trigger may utilize downlink (DL) measurements of the relay UE 104. For example, the relay UE 104 may provide intra-frequency, inter-frequency, and inter-RAT measurements to the network for a determination whether the criteria for a switching from a first base station 102-a to the second base station 102-b are met. In some cases, the network 190 may decide when to initiate the switch based on the DL measurements. In other cases, the relay UE 104 may decide and initiate the switch using the DL measurements. Upon taking action to initiate the switch, a target link (Uu connection) with the second base station 102-b may be established.

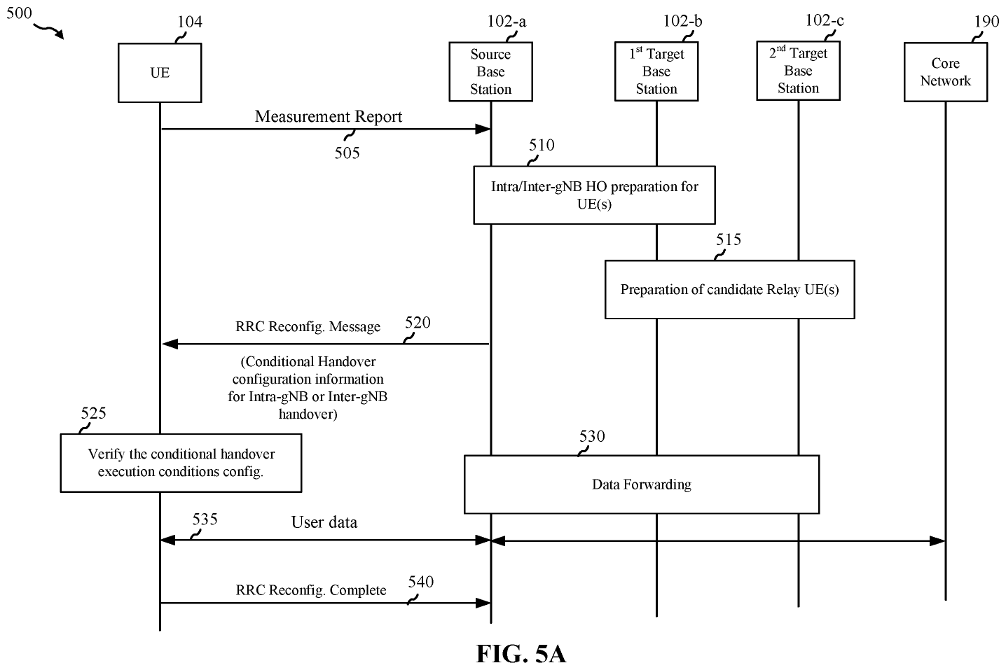

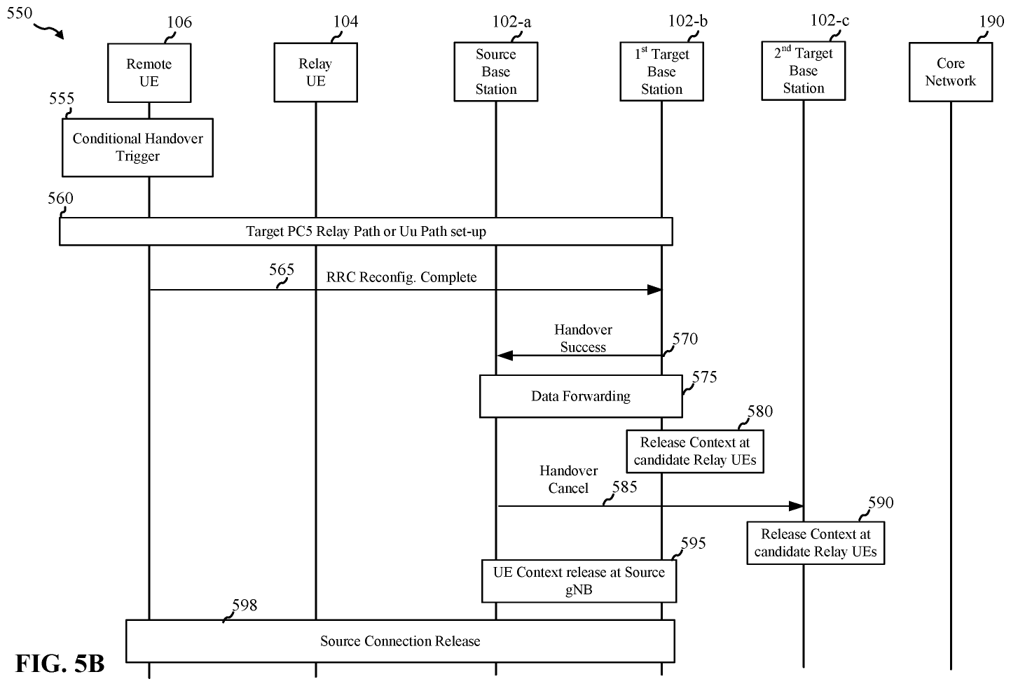

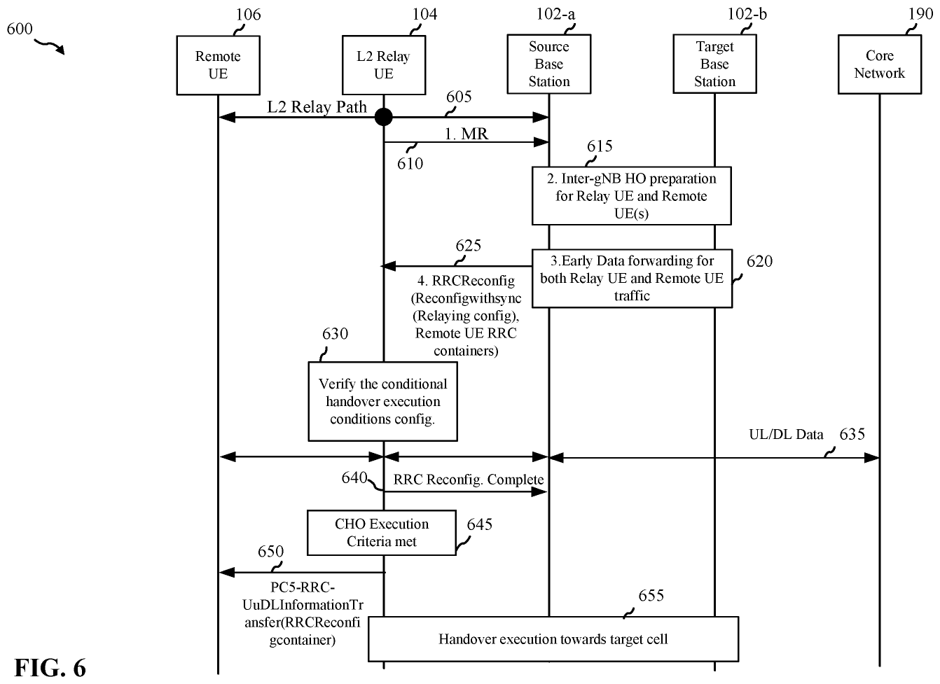

As discussed in more detail below with reference to FIGS. 5A, 5B, and 6, the UEs may be configured for conditional handover for UE mobility between a direct connection to the base station (Uu connection) and/or a relay connection (PC5 connection). Specifically, the conditional handover configuration may include preparing multiple candidate relay UEs for handover (e.g., from Uu connection to PC5 connection) and conditional handover execution criteria for relay selection (or reselection) for the UE. Similarly, features of the present disclosure provide techniques for conditional handover transition from a PC5 connection back to Uu connection when conditional handover execution criteria are met (e.g., sidelink signal strength between the two UEs falls below a channel condition threshold). Additionally, the techniques provided herein support for conditional handover of the relay UEs from a first base station to a second station while the relay UE is further supporting one or more remote UEs.

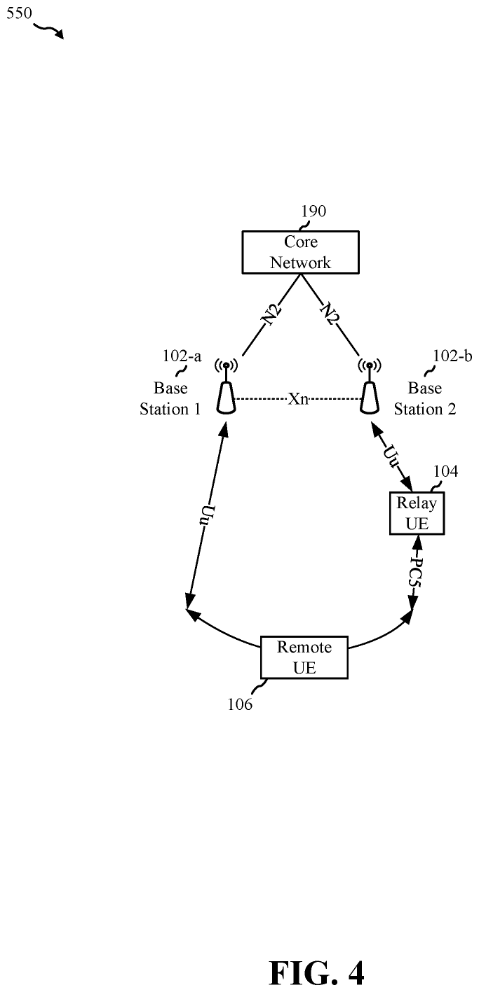

Similarly, in some scenarios such as in FIG. 4, the remote UE 106 may switch communications from a direct base station 102-a to a relay communication via the relay UE 104. In such situation, the mobility trigger may utilize DL measurements of the remote UE 106. For example, the remote UE 106 may provide intra-frequency, inter-frequency, and inter-RAT measurements to the network 190 for a determination whether the criteria for a switch are met. In some cases, the network 190 may decide when to initiate the switch based on the DL measurements. In other cases, the remote USE 106 may decide and initiate the switch using the DL measurements.

Upon taking action to initiate the switch, a target link (either a PCS connection or a Uu connection) may be established. The target link establishment may include a context transfer before the remote UE 106 switches to the target link. For example, the switch may include the target link establishment as well as configuration of dedicated/common UE resources based on the context of the existing connection of the remote UE. Upon completion, the switch may include forwarding data from the source connection to the target connection. In some cases, a U-plane switch may be included. In other cases, release resources at the source cell may also be included.

FIG. 5A is a flow diagram 500 illustrating an example communication flow of a preparation of conditional handover between a Uu plane and a PC5 plane (and vice versa) for the scenario described with reference to FIG. 4. Initially, a UE 104 may be communicatively coupled with a source base station 102-a via a Uu path and may have access to the core network 190.

At 505, in one aspect, the source base station 102-a may receive one or more measurement reports from the UE 104. The measurement report may, for example, signal channel condition measurements between the UE 104 and the source base station 102-a that may be deteriorating. Based at least in part on the one or more received measurement reports from the UE 104, the source base station 102-a may determine to configure conditional handover procedure, e.g., moving the UE 104 to a target base station 102-b, in the event that signal quality continues to deteriorate below the channel condition threshold.

If the source base station 102-a determines to initiate the conditional handover based on the measurement report, the source base station 102-b, at 510, may configure one or both of intra-gNB or inter-gNB handover preparations (collectively, “conditional handover preparations”) for the UE 104. Specifically, the handover may be an inter-base station (e.g., inter-gNB) handover, or the handover may be an intra-base station (e.g., intra-gNB) handover. The source base station 102-a may communicate with the target base stations 102-b, 102-c via an Xn network interface.

The conditional handover preparations may include identifying and configuring the source base station 102-a and/or candidate target base stations (e.g., first target gNB 102-b and/or second target gNB 102-c). In some aspects, the conditional handover preparations may prepare conditional handover configuration for the UE 104. Such preparation may include identifying criteria for the UE 104 to select one or more relay UEs 104. For example, the criteria may include determining whether the UE 104 that satisfy a sidelink discovery reference signal power (SD-RSRP) for transitioning from Uu connection to PC5 connection (e.g., from direct base station connection to a relay connection) and/or sidelink reference signals received power (SL-RSRP) for UEs 104 moving from PC5 connection to the Uu connection (e.g., from the relay connection via a relay UE to a direct base station connection). For purposes of this disclosure, the SD-RSRP and/or SL-RSRP may collectively he referred to as “sidelink channel condition.”

Specifically, one or both of the source base station 102-a and/or candidate target base stations 102-b, 102-c may prepare one or more relay UEs 104 (see FIGS. 2-4) for the UE 104 to connect via a PC5 connection that provides access to the one or more base stations 102. The one or more relay UEs 104 may be within the coverage area of the one or more of the source base station 102-a and/or target base stations 102-b, 102-c, and may communicate with the base stations 102 via a Uu connection. Thus, as discussed above, in preparation of the one or more relay UEs 104 as part of the conditional handover procedure, the base stations 102 may provide conditional handover configuration information that may include the criteria for the UE 104 to execute for conditional handover between the Uu to PC5 handover (e.g., from base source base station 102-a to one or more relay UEs 104) and from the PC5 back to Uu handover (e.g., from the one or more relay UEs 104 back to one of the base stations, including source base station 102-a or the target base stations 102-b and 102-c).

At 520, the source base station 102-a may send a RRC reconfiguration message to the UE 104. The RRC reconfiguration message may include conditional handover configuration information for both intra-gNB and/or inter-gNB handover. The conditional handover configuration information may indicate to the UE 104 the specific criteria upon which the UE 104 may execute the conditional handover and the criteria for selecting one or more relay UEs 104. Thus, at 525, the UE 104 may verify the conditional handover configuration information that includes determining whether the channel condition (e.g., signal strength) between the UE 104 and the source base station 102-a, via Uu connection, falls below the channel condition threshold. If the channel conditions fall below the channel condition threshold, the UE 104 may identify one or more relay UEs 104 that have been configured by the source base station 102-a (e.g., UEs 104 that are connected to source base station 102-a in terms of intra-gNB handover) and one of a plurality of candidate target base stations 102-b, 102-c (e.g., UEs that are connected to one or both of candidate target base stations 102-b, 102-c in terms of inter-gNB handover).

Thus, in some aspects, the UE 104 may select the relay UE 104 to handover to the PC5 connection based on the conditional handover configuration information verified at 525. At 530, as part of the conditional handover configuration, the source base station 102-a may forward the pending data to one or both of candidate target base stations 102-b, 102-c. However, while the UE 104 performs handover to the candidate target base stations 102 via a relay LIE 104 associated with one of the candidate target base stations 102, the UE 104 may maintain the Uu connection with the source base station 102-a in order to minimize communication interruptions. As such, at 535, the user data may be communicated between the UE 104 and the core network 190 via the source base station 102-a. At 540, the UE 104 may transmit the RRC reconfiguration complete message to the source base station 102-a.

FIG. 5B is a flow diagram 550 illustrating an example communication flow of a triggering conditional handover between a Uu plane and a PC5 plane (and vice versa) for scenario described with reference to FIG. 4. In some aspects, the flow diagram 550 may sequentially follow after the steps described in flow diagram 500 with reference to FIG. 5A.

At 555, the remote UE 106 may trigger a conditional handover upon determining that the conditional handover trigger criteria are met. In some aspects, the conditional handover trigger criteria may be preconfigured or received from the source base station 102-a (see FIG. 5A). In response to the determination that the conditional handover trigger criteria is met, the remote UE 104 may verify target base station configuration that includes identifying one or more candidate relay UEs 104 and verify the availability of target path configuration (e.g., PC5 or Uu path) to one or more target base stations 102-b, 102-c. And while the remote UE 106 executes conditional handover process, the remote UE 106 may maintain the connection with the source base station 102-a until the target path is setup. As such, until the remote UE 104 completes the handover from the Uu to the PC5 connection (or vice versa), the remote UE 104 and the source base station 102-a may continue to exchange data.

At 560, the remote UE 106 may setup target access path (e.g., PC5 or Uu path) to the target base station 1024), 102-c via a candidate relay UEs 104 (PC5 connection). in some examples, the access path may include selecting a relay UE 106 from a plurality of candidate relay UEs configured by one or more of source base station 102-a, first target base station 102-b, and/or second target base station 102-c. In some examples, the selected relay UE 104 may be within the coverage area of the first target base station 102-b, and therefore in communication with the first target base station 102 via the Uu path. The relay UE 104 may be selected from the plurality of candidate relay UEs 104 by the remote UE 106 based on the sidelink channel condition criteria discussed above (e.g., SD-RSRP and/or SL-RSRP).

At 565, the remote UE 106 may transmit an RRC reconfiguration complete message to the first target base station 102-b after the target access path has been setup between the remote UE 106, the relay UE 104, and the first target base station 102-b. At 570, the first target base station 102-b may transmit a handover success message to the source base station 102-a.

At 575, the source base station 102-a may forward all pending data associated with the remote UE 106 to the first target base station 102-b. At 580, the first target base station 102-b may release the remote UE context from the configured candidate relay UEs that are not selected by the remote UE 106. In other words, once the remote UE 106 selects a relay UE 104 from a plurality of candidates relay UEs for the PC5 communications based on one or more configured criteria (e.g., SD-RSRP and/or SL-RSRP), the target base stations 102-b, 102-c may release the remote UE 104 context for all of the remaining candidate relay UEs.

Similarly, at 585, the source base station 102-a may transmit a message (e.g., handover cancel message) to the second target base station 102-c identifying that the remote UE 106 has initiated a conditional handover connection with the first target base station 102-b. In other examples, the source base station 102-a may transmit a message (e.g., handover cancel message) to indicate that the second target base station 102-c is no longer needed for handover for the remote UE 106. As such, the second target base station 102-c, at 590, may also release the remote UE 106 context from the configured candidate relay UEs setup by the second target base station 102-c. At 595, the source base station 102-a may release the remote UE context as well, and at 598, the source connection between the remote UE 106 and the source base station 102-a is released following handover to the first target base station 102-b (via the relay UE 104).

While FIGS. 5A and 5B illustrate the Uu to PC5 mobility for the UE 104, it should be appreciated that the same procedures may also be adapted for the PC5 back to Uu mobility. Indeed, the RRC reconfiguration message 520, for instance, may include conditional handover configuration information that also notifies the UE 104 the conditions upon which the UE 104 may handover back to one of the base stations 102 via a Uu connection. One such criteria may include conditions where the sidelink channel condition (e.g., SL-RSRP) connection between the UE 104 and the relay UE 104 over PCS connection falls below a sidelink connection threshold, while the RSRP between the UE 104 and the base station 102 (either source base station 102-a and/or candidate target base stations 102-b, 102-c) exceeds the channel condition threshold. In such scenario, the conditional handover conditions may dictate handing over from reliance of relay UE 104 to directly connect with the base station 102 via the Uu connection.

FIG. 6 is a flow diagram 600 illustrating an example communication flow of a relay UE mobility that triggers conditional handover for scenario described with reference to FIG. 3. In this example, the relay UE 104 may move from the coverage area of the first base station 102-a to the second base station 102-b. The relay UE 104 may also provide relay connections (PC5 connection) to one or more remote UEs (e.g., first remote UE 106-a and second remote UE 106-b). In some aspects, the remote UEs 106 may maintain the PC5 connection with the relay UE 104 during the handover process or they may trigger a handover to another relay UE or direct Uu path to a target base station 102,

At 605, a remote UE 106 may be communicatively coupled to a relay UE 104, and the relay UE 104 may in turn be communicatively coupled to to a source base station 102-a. The remote UE 106 may communicate with the base station 102-a, and may have access to the core network 190, via the relay UE 106. At 610, in one aspect, the source base station 102-a may receive one or more measurement reports from the relay UE 104 and/or the remote UE 106 (e.g., at 605 or via the relay UE 104 at 610). Based at least in part on the received measurement reports from the relay UE 104 and/or the remote UE 106, the source base station 102-a may decide whether to initiate a handover procedure, e.g., moving the relay UE 104 and optionally the remote UE 106 to a target base station 102-b. In some aspects, the source base station 102-a may configure conditional handover for relay UE 104 and/or remote UEs 106.

In another aspect, the measurement reports from the relay UE 104 may indicate which remote UE(s) (e.g., the likely candidates such as 106-a and/or 106-b in FIG. 3) may move with the relay UE 104 during the handover. Additionally or alternatively, the relay UE 104 may decide which remote UE(s) 106 to bring along during the handover for the relay UE 105 based at least in part on a sidelink measurement report (e.g., channel condition between the first UE and the second UE) between the relay UE 104 and the remote UE(s) 106. Thus, based on the indication, the source base station 102-a may also determine which remote UE(s) 106 may potentially be included in the conditional handover preparation (e.g., a group handover).

If the source base station 102-a determines to initiate the group handover, at 615, the source base station 102-a may configure one or more dedicated radio bearers (DRBs) of the remote UE 106 as Dual Active Protocol Stack (DAPS) DRBs, where the remote UE 106 may continue to transmit and/or receive data using the DAPS DRBs during the group handover, such as described in connection with FIG. 3. For example, as the remote UE 106 may have its own non-access stratum (NAS) and Uu access stratum (AS) connections to the source base station 102-a, the remote LIE 106 may also have its own packet data unit (PDU) sessions and DRBs set up, Thus, the source base station 102-a may determine that one or more of the DRBs for the remote UE 106 may correspond to certain services that may be more susceptible to interruption during an handover, and may decide to configure them as DAPS DRBs. Particularly, while the DAPS DRBs configuration(s) may be known to the remote UE 106, the relay UE 104 may not know about the DAPS DRBs configuration(s).

Thus, to support DAPS DRBs configuration for the remote UE 106 during a relay UE handover (e.g., mobility), the source base station 102-a may inform the relay UE 104 which Uu radio link control (RLC) channels of the remote UE 106 may be handled as DAPS Uu RLC channels. In one example, the source base station 102-a may indicate the DAPS RLC channels of the remote UE 106 to the relay UE 104 during an initial configuration of the Uu RLC channels for each remote UE. This may provide the source base station 102-a with a dynamic control over the DAPS RLC channels configuration, where the configuration may be based at least in part on the loading and traffic conditions. For example, during the handover, if the source channel does not have a good channel condition or the source channel is loaded or the target base station does not support DAPS configuration, then the source channel may not be configured to support the DAPS. In another example, the source base station 102-a may indicate the DAPS RLC channels of the remote UE 106 in a handover command that is sent to the relay UE 104 for group handover. For example, when a source base station 102-a is moving a relay UE 104 from the source base station 102-a to a target base station 102-b, the source base station 102-a may also indicate to the relay UE 104 any Uu RLC channels that are being handled by the remote UE 106 and which of them are DAPS RLC channels in the handover command of the group handover, etc.

At 615, the source base station 102-a may prepare the target base station 102-b for the conditional handover operation of the relay UE 104 and the remote UE 106, which may also include the DAPS DRBs preparation. The handover may be an inter-base station (e.g., inter-gNB) handover, or the handover may be an intra-base station (e.g., intra-gNB) handover. The source base station 102-a may communicate with the target base station 102-b via an Xn network interface. In one example, the source base station 102-a may send the handover preparation message for the relay UE 104 and each of the remote UEs 106 to the target base station 102-b. For example, referring back to FIG. 3, if the base station 102-a is preparing to move the relay UE 104 and the remote UEs 106-a and 106-b to the target base station 102-b, the source base station 102-a may send four preparation messages: one to the target base station 102-b, one for the relay UE 104, one for the first remote UE 106-a and one for the second remote UE 106-b, etc. The source base station 102-a may also inform the target base station 102-b which DRBs are to be handled as DAPS in the preparation message(s). Alternatively, the source base station 102-a may send a handover preparation message to the target base station 102-b, where the handover preparation message may inform the target base station 102-b to configure the relay UE 104 and one or more remote UEs 106 for the conditional handover. In some aspects, preparing for conditional handover for relay UE 104 may also include preparing the conditional handover cells for remote UEs' 106 mobility as well.

After the target base station 102-b receives the handover preparation message(s), the target base station 102-b may determine whether the handover and/or handover configurations) are supported, and may send acknowledgement message(s) to the source base station 102-a, such as confirming the handover request and/or the supported handover configuration(s) (e.g., DAPS DRBs configurations). At 620, early or late data forwarding for both the relay UE 104 and the remote UE 106's traffic may be supported using the DAPS DRBs at the source base station 102-a and/or the target base station 102-b.

At 625, the source base station 102-a may send the conditional handover configuration command, such as via a RRC reconfiguration message, to the relay UE 104 and/or the remote UE 106 informing the relay UE 104 and/or the remote UE 106 the criteria(s) that may trigger a move from the source base station 102-a to the target base station 102-b. In some aspects, the conditional handover configuration information for the relay UE 104 may further include conditional handover criteria for the one or more remote UE handover command container(s). Additionally, the relay UE 104 may be provided with remote UE handover command containers in addition to the conditional handover configuration.

At 630, the relay LIE 104 may verify the conditional handover execution criteria and start monitoring conditional handover cells that are prepared by the network. And, while the relay UE 104 performs the verification, the relay UE 104 may maintain its Uu connection with the source base station 102-a in order to minimize communication interruptions. As such. at 635, the user data may continue to be communicated between the relay UE 104, remote UE 106, and the core network 190 via the source base station 102-a. At 640, the UE 104 may transmit the RRC reconfiguration complete message to the source base station 102-a.

At 645, the relay UE 104 may determine that the conditional handover execution criteria are met (e.g., the channel conditions between the relay UE 104 and the source base station 102-a fall below the channel condition threshold). At 650, the relay UE 104 may wait for the conditional handover execution criteria to be met before relaying to the remote UE 106 a handover command. In some aspects the relay UE 104 may relay the handover command to the one or more remote UEs 106 at different times based on non-DAPS DRBs configured for the one or more remote UE 106.

By sending the remote UE 106 a handover command with handover command container(s), the relay UE 104 may have more control over the handover procedure, and may inform the remote UE 106 about the target base station 102-b. For example, as the relay UE 104 may have one or more Uu RLC channels for the remote UE 106 which may be DAPS RLC channels, the remote UE may have been transmitting and/or receiving data with the source base station 102-a using the DAPS RLC channels. At 655, after the relay UE 104 initiates the handover procedure based on the determination that the conditional handover criteria are met, the remote UE 106 may continue to transmit data to the source base station 102-a using its DAPS RIX channels while the relay UE 104 is performing the RRC connection with the target base station 102-b. However, after the relay UE 104 completes the RRC connection with the target base station 102-b, the relay UE 104 may inform the remote UE 106 about the target base station 102-b and connect the remote UE 106 (e.g., by sending the remote UE handover command container) to the target base station 102-b.

Thus, in one example, the relay UE 104 may transmit the handover command to the one or more remote UEs 106 upon the determination that the conditional handover execution criteria are met and on starting the handover execution. In other examples, the handover command may be sent upon a successful handover execution to the target base station 102-b. In either instance, the remote UE 106 may then transmit and receive data from the target base station 102-b after the relay UE 104 has executed the handover to the target base station 102-b. This approach may be beneficial as it minimizes interruption in data transmission for the remote UE 106.

FIG. 7 illustrates a hardware components and subcomponents of a device that may be a UE 104 for implementing one or more methods (e.g., method 800) described herein in accordance with various aspects of the present disclosure. In some examples, the UE 104 may be the relay UE 104 or remote UE 106 described with reference to FIGS. 1-6. For example, in one example of an implementation of the UE 104 may include a variety of components, some of which have already been described above, but including components such as one or more processors 712, memory 716 and transceiver 702 in communication via one or more buses 744, which may operate in conjunction with the conditional handover configuration component 750 to perform functions described herein related to including one or more methods (e.g., 800) of the present disclosure.

In some aspects, the conditional handover configuration component 750 is configured to handle data transmission during a handover procedure, such as relaying data transmission for during a handover procedure. The conditional handover configuration component 750 may also trigger the handover process based on determining that one or more conditional handover criteria are met.

The one or more processors 712, modem 714, memory 716, transceiver 702, RF front end 788 and one or more antennas 765, may be configured to support voice and/or data calls (simultaneously or non-simultaneously) in one or more radio access technologies. In an aspect, the one or more processors 712 can include a modem 714 that uses one or more modem processors. The various functions related to conditional handover configuration component 750 may be included in modem 714 and/or processors 712 and, in an aspect, can be executed by a single processor, while in other aspects, different ones of the functions may be executed by a combination of two or more different processors. For example, in an aspect, the one or more processors 712 may include any one or any combination of a modem processor, or a baseband processor, or a digital signal processor, or a transmit processor, or a receiver processor, or a transceiver processor associated with transceiver 702. In other aspects, some of the features of the one or more processors 71:2 and/or modem 714 associated with conditional handover configuration component 750 may be performed by transceiver 702.

The memory 716 may be configured to store data used herein and/or local versions of application(s) 775 or conditional handover configuration component 750 and/or one or more of its subcomponents being executed by at least one processor 712. The memory 716 can include any type of computer-readable medium usable by a computer or at least one processor 712, such as random access memory (RAM), read only memory (ROM), tapes, magnetic discs, optical discs, volatile memory, non-volatile memory, and any combination thereof. In an aspect, for example, the memory 716 may be a non-transitory computer-readable storage medium that stores one or more computer-executable codes defining conditional handover configuration component 750 and/or one or more of its subcomponents, and/or data associated therewith, when the OF 104 is operating at least one processor 712 to execute conditional handover configuration component 750 and/or one or more of its subcomponents.

The transceiver 702 may include at least one receiver 706 and at least one transmitter 708. The receiver 706 may include hardware, firmware, and/or software code executable by a processor for receiving data, the code comprising instructions and being stored in a memory (e.g., computer-readable medium). The receiver 706 may be, for example, a radio frequency (RF) receiver. In an aspect, the receiver 706 may receive signals transmitted by at least one UE 104. Additionally, receiver 706 may process such received signals, and also may obtain measurements of the signals, such as, but not limited to, Ec/Io, SNR, RSRP, RSSI, etc. The transmitter 708 may include hardware, firmware, and/or software code executable by a processor for transmitting data, the code comprising instructions and being stored in a memory (e.g., computer-readable medium). A suitable example of the transmitter 508 may including, but is not limited to, an RF transmitter.

Moreover, in an aspect, transmitting device may include the RF front end 788, which may operate in communication with one or more antennas 765 and transceiver 702 for receiving and transmitting radio transmissions, for example, wireless communications transmitted by at least one base station 102 or wireless transmissions transmitted by UE 104. The RF front end 788 may be connected to one or more antennas 765 and can include one or more low-noise amplifiers (LNAs) 790, one or more switches 792, one or more power amplifiers (PAs) 798, and one or more filters 796 for transmitting and receiving RF signals.

In an aspect, the INA 790 can amplify a received signal at a desired output level. In an aspect, each LNA 790 may have a specified minimum and maximum gain values. In an aspect, the RF front end 788 may use one or more switches 592 to select a particular LNA 790 and its specified gain value based on a desired gain value for a particular application.

Further, for example, one or more PA(s) 798 may be used by the RF front end 788 to amplify a signal for an RF output at a desired output power level. In an aspect, each PA 798 may have specified minimum and maximum gain values. In an aspect, the RF front end 788 may use one or more switches 792 to select a particular PA 598 and its specified gain value based on a desired gain value for a particular application.

Also, for example, one or more filters 796 can be used by the RF front end 788 to filter a received signal to obtain an input RF signal. Similarly, in an aspect, for example, a respective filter 796 can be used to filter an output from a respective PA 798 to produce an output signal for transmission. In an aspect, each filter 796 can be connected to a specific LNA 790 and/or PA 798. In an aspect, the RF front end 788 can use one or more switches 792 to select a transmit or receive path using a specified filter 796, LNA 790, and/or PA 798, based on a configuration as specified by the transceiver 702 and/or processor 712.

As such, the transceiver 702 may be configured to transmit and receive wireless signals through one or more antennas 765 via the RE front end 788. In an aspect, the transceiver 702 may be tuned to operate at specified frequencies such that transmitting device can communicate with, for example, one or more base stations 102 or one or more cells associated with one or more base stations 102 or other UEs 104. In an aspect, for example, the modem 714 can configure the transceiver 702 to operate at a specified frequency and power level based on the configuration of the transmitting device and the communication protocol used by the modem 714.

In an aspect, the modem 714 can he a multiband-multimode modem, which can process digital data and communicate with the transceiver 702 such that the digital data is sent and received using the transceiver 702. In an aspect, the modem 714 can be multiband and be configured to support multiple frequency bands for a specific communications protocol. In an aspect, the modem 714 can be multimode and be configured to support multiple operating networks and communications protocols. In an aspect, the modem 714 can control one or more components of transmitting device (e.g., RF front end 788, transceiver 702) to enable transmission and/or reception of signals from the network based on a specified modem configuration. In an aspect, the modem configuration can be based on the mode of the modem 714 and the frequency band in use. In another aspect, the modem configuration can be based on UE configuration information associated with transmitting device as provided by the network during cell selection and/or cell reselection.

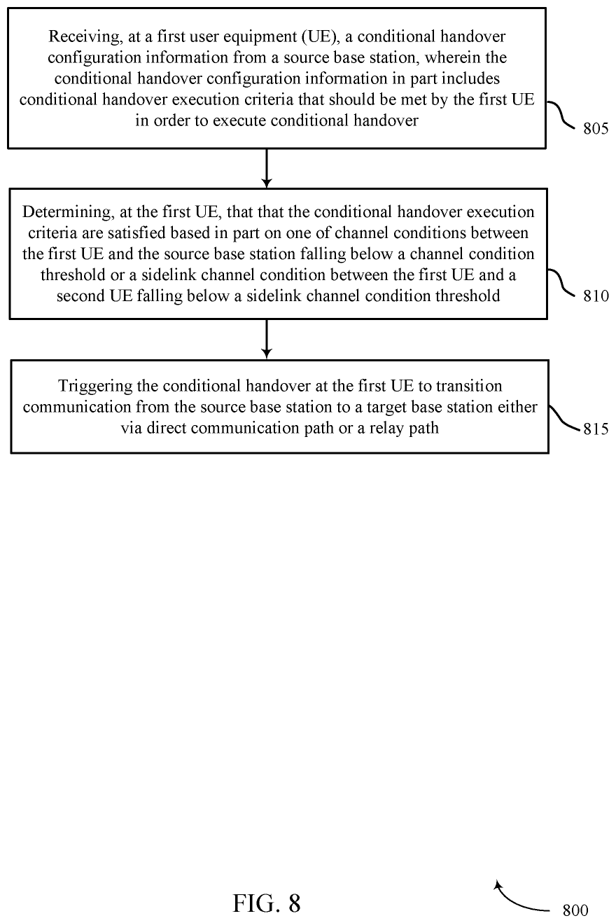

Referring to FIG. 8, an example method 800 for wireless communications in accordance with aspects of the present disclosure may be performed by one or more UEs 104 discussed with reference to FIGS. 1-6. Although the method 800 is described below with respect to the elements of the UE 104, other components may be used to implement one or more of the steps described herein.

At block 805, the method 800 may include receiving, at a first user equipment (UE), conditional handover configuration information from a source base station, wherein the conditional handover configuration information, in part, includes conditional handover execution criteria that should be met by the first UE in order to execute conditional handover. Aspects of block 805 may be performed by the transceiver 702 that receives signals detected on one or more antennas 765 as described with reference to FIG. 7. The detected signals are filtered through the RF front end 788 of the UE 104 and forwarded to the modem 714 to be processed by conditional handover configuration component 750. Thus, one or more antennas 765, transceiver 702, conditional handover configuration component 750, modem 714, processor 712, and/or the UE 104 or one of its subcomponents may define the means for receiving, at a first user equipment (UE), conditional handover configuration information from a source base station.

In some examples, the first UE may be in communication with the source base station via the direct communication path prior to triggering the conditional handover. In such scenario, the conditional handover configuration information may include information regarding a plurality of candidate relay UEs prepared by the target base station for the first UE to select from for the relay path to the target base station.

At block 810, the method 800 may include determining, at the first UE, that that the conditional handover execution criteria are satisfied based in part on one of channel conditions between the first UE and the source base station falling below a channel condition threshold or a sidelink channel condition between the first UE and a second UE falling below a sidelink channel condition threshold. Aspects of block 810 may also be performed by the conditional handover configuration component 750. Thus, one or more antennas 765, transceiver 702, conditional handover configuration component 750, modem 714, processor 712, and/or the UE 104 or one of its subcomponents may define the means for determining, at the first UE, that that the conditional handover execution criteria are satisfied based in part on one of channel conditions between the first UE and the source base station falling below a channel condition threshold or a sidelink channel condition between the first LIE and a second UE falling below a sidelink channel condition threshold.

In some aspects, the first UE may be in communication with the source base station via the relay path prior to triggering the conditional handover. In such situation, determining that that the conditional handover execution criteria are satisfied may comprise measuring sidelink reference signals received power (SL-RSRP) between the first UE and the second UE, and determining that the SL-RSRP falls below the sidelink channel condition threshold.

At block 815, the method 800 may include triggering the conditional handover at the first UE to transition communication from the source base station to a target base station either via direct communication path or a relay path. Aspects of block 810 may also be performed by the conditional handover configuration component 750. Thus, one or more antennas 765, transceiver 702, conditional handover configuration component 750, modem 714, processor 712, and/or the UE 104 or one of its subcomponents may define the means for triggering the conditional handover at the first UE to transition communication from the source base station to a target base station either via direct communication path or a relay path.

In some examples, triggering the conditional handover at the first UE to transition the communication from the source base station to the target base station may comprise maintaining communication with the source base station while a target path to the target base station is setup via either the direct communication path or the relay path.

In some aspects, the first UE may be a relay UE for one or more remote UEs to communicate with the source base station prior to triggering the conditional handover. As such, triggering the conditional handover at the first UE to transition the communications from the source base station to the target base station, may comprise receiving, at the first UE, a remote UE handover command from the source base station as part of the conditional handover configuration information. The first UE may then transmit the remote UE handover command from the first UE to the one or more remote UEs upon triggering the conditional handover, wherein the one or more remote UEs reconfigure connection to the target base station via the first UE.

In some examples, the method may include selecting a relay UE from the plurality of candidate relay UEs prepared by the target base station for the first UE based in part on measurement of sidelink discovery reference signals received power (SD-RSRP) between the first UE and each of the plurality of candidate relay UEs.

FIG. 9 illustrates a hardware components and subcomponents of a device that may be a base station 102 for implementing one or more methods (e.g., method 1000) described herein in accordance with various aspects of the present disclosure. In some examples, the base station 102 may be a source base station or a target base station for configuring conditional handover as described with reference to FIGS. 1-6. For example, in one example of an implementation of the base station 102 may include a variety of components, some of which have already been described above, but including components such as one or more processors 912, memory 916 and transceiver 902 in communication via one or more buses 844, which may operate in conjunction with the handover component 950 to perform functions described herein related to including one or more methods (e.g., 900) of the present disclosure.

In some aspects, the handover component 950 is configured to configure and initiate the handover procedure to move the UE 104 and the UE 106 to another base station (or vice versa). For example, the handover component 950 may receive one or more measurement report from the UE 104 and/or UE 106, and may determine whether to initiate a handover procedure based at least in part on the measurement report, and to identify the conditional handover execution triggers for one or more UEs.

The one or more processors 912, modem 914, memory 916, transceiver 902, RE front end 988 and one or more antennas 965, may be configured to support voice and/or data calls (simultaneously or non-simultaneously) in one or more radio access technologies. In an aspect, the one or more processors 912 can include a modem 914 that uses one or more modem processors. The various functions related to handover component 950 may be included in modem 914 and/or processors 912 and, in an aspect, can he executed by a single processor, while in other aspects, different ones of the functions may be executed by a combination of two or more different processors. For example, in an aspect, the one or more processors 912 may include any one or any combination of a modem processor, or a baseband processor, or a digital signal processor, or a transmit processor, or a receiver processor, or a transceiver processor associated with transceiver 902. In other aspects, some of the features of the one or more processors 912 and/or modem 914 associated with handover component 950 may be performed by transceiver 902.

The memory 916 may be configured to store data used herein and/or local versions of application(s) 975 or handover component 950 and/or one or more of its subcomponents being executed by at least one processor 912. The memory 916 can include any type of computer-readable medium usable by a computer or at least one processor 912, such as random access memory (RAM), read only memory (ROM), tapes, magnetic discs, optical discs, volatile memory, non-volatile memory, and any combination thereof. In an aspect, for example, the memory 916 may be a non-transitory computer-readable storage medium that stores one or more computer-executable codes defining handover component 950 and/or one or more of its subcomponents, and/or data associated therewith, when the base station 102 is operating at least one processor 912 to execute handover component 950 and/or one or more of its subcomponents.

The transceiver 902 may include at least one receiver 906 and at least one transmitter 908. The receiver 906 may include hardware, firmware, and/or software code executable by a processor for receiving data, the code comprising instructions and being stored in a memory (e.g., computer-readable medium). The receiver 906 may be, for example, a radio frequency (RF) receiver. In an aspect, the receiver 906 may receive signals transmitted by at least one UE 104. Additionally, receiver 906 may process such received signals, and also may obtain measurements of the signals, such as, but not limited to, Ec/Io, SNR, RSRP, RSSI, etc. The transmitter 908 may include hardware, firmware, and/or software code executable, by a processor for transmitting data, the code comprising instructions and being stored in a memory (e.g., computer-readable medium). A suitable example of the transmitter 908 may including, but is not limited to, an RF transmitter.

Moreover, in an aspect, transmitting device may include the RE front end 988, which may operate in communication with one or more antennas 965 and transceiver 902 for receiving and transmitting radio transmissions, for example, wireless communications transmitted by LIE 104. The RE front end 988 may be connected to one or more antennas 965 and can include one or more low-noise amplifiers (LNAs) 990, one or more switches 992, one or more power amplifiers (PAs) 998, and one or more filters 996 for transmitting and receiving RE signals.

In an aspect, the LNA 990 can amplify a received signal at a desired output level. In an aspect, each LNA 990 may have a specified minimum and maximum gain values. In an aspect, the RF front end 988 may use one or more switches 992 to select a particular LNA 990 and its specified gain value based on a desired gain value for a particular application.

Further, for example, one or more PA(s) 998 may be used by the RF front end 988 to amplify a signal for an RF output at a desired output power level. In an aspect, each PA 998 may have specified minimum and maximum gain values. In an aspect, the RF front end 988 may use one or more switches 992 to select a particular PA 998 and its specified gain value based on a desired gain value for a particular application.

Also, for example, one or more filters 996 can be used by the RE front end 988 to filter a received signal to obtain an input RF signal. Similarly, in an aspect, for example, a respective filter 996 can be used to filter an output from a respective PA 998 to produce an output signal for transmission. In an aspect, each filter 796 can be connected to a specific LNA 990 and/or PA 998. In an aspect, the RE from end 988 can use one or more switches 992 to select a transmit or receive path using a specified filter 996. LNA 990, and/or PA 998, based on a configuration as specified by the transceiver 902 and/or processor 912.

As such, the transceiver 902 may be configured to transmit and receive wireless signals through one or more antennas 965 via the RE front end 788. In an aspect, the transceiver 902 may be tuned to operate at specified frequencies such that transmitting device can communicate with, for example, one or more UEs 104. In an aspect, for example, the modem 914 can configure the transceiver 902 to operate at a specified frequency and power level based on the configuration of the transmitting device and the communication protocol used by the modem 914.

In an aspect, the modem 914 can he a multiband-multimode modem, which can process digital data and communicate with the transceiver 902 such that the digital data is sent and received using the transceiver 902. In an aspect, the modem 914 can be multiband and he configured to support multiple frequency bands for a specific communications protocol. In an aspect, the modem 914 can be multimode and be configured to support multiple operating networks and communications protocols. In an aspect, the modem 914 can control one or more components of transmitting device (e.g., RF front end 988, transceiver 902) to enable transmission and/or reception of signals from the network based on a specified modem configuration. In an aspect, the modem configuration can be, based on the mode of the modem 914 and the frequency band in use. In another aspect, the modem configuration can he based on base station configuration information associated with transmitting device as provided by the network during cell selection and/or cell reselection.

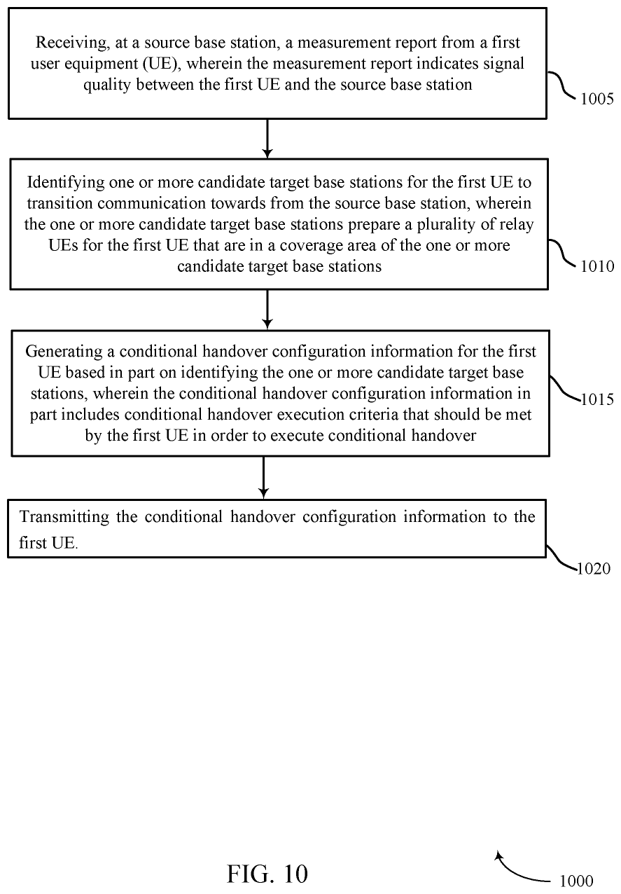

Referring to FIG. 10, an example method 1000 for wireless communications in accordance with aspects of the present disclosure may be performed by one or more base stations 102 discussed with reference to FIGS. 1-6. Although the method 1000 is described below with respect to the elements of the base station 102, other components may be used to implement one or more of the steps described herein.

At block 1005, the method 1000 may include receiving, at a source base station, a measurement report from a first user equipment (UE), wherein the measurement report indicates signal quality between the first UE and the source base station. Aspects of block 1005 may be performed by the transceiver 905 that receives signals detected on one or more antennas 965 as described with reference to FIG. 9. The detected signals are filtered through the RF front end 988 of the base station 102 and forwarded to the modem 914 to he processed by the handover component 950. Thus, one or more antennas 965, transceiver 902, handover component 950, modem 914, processor 912, and/or the base station 102 or one of its subcomponents may define the means for receiving, at a source base station, a measurement report from a first user equipment (UE), wherein the measurement report indicates signal quality between the first UE and the source base station.

At block 1010, the method 1000 may include identifying one or more candidate target base stations for the first UE to transition communication towards from the source base station, wherein the one or more candidate target base stations prepare a plurality of relay UEs for the first UE that are in a coverage area of the one or more candidate target base stations. In some aspects, the one or more candidate target base stations further prepare conditional handover cells for one or more remote UEs that are in communication with the first UE. Aspects of block 1010 may be performed by the handover component 950 described with reference to FIG. 9. Thus, one or more antennas 965, transceiver 902, handover component 950, modem 914, processor 912, and/or the base station 102 or one of its subcomponents may define the means for identifying one or more candidate target base stations for the first UE to transition communication towards from the source base station, wherein the one or more candidate target base stations prepare a plurality of relay UEs for the first LIE that are in a coverage area of the one or more candidate target base stations.

At block 1015, the method 1000 may include generating a conditional handover configuration information for the first UE based in part on identifying the one or more candidate target base stations, wherein the conditional handover configuration information in part includes conditional handover execution criteria that should be met by the first LIE in order to execute conditional handover. In some examples, the conditional handover configuration information may further include a remote UE handover command for the first UE to forward to one or more remote UEs when triggering conditional handover. Aspects of block 1010 may be performed by the handover component 950 described with reference to FIG, 9. Thus, one or more antennas 965, transceiver 902, handover component 950, modem 914, processor 912, and/or the base station 102 or one of its subcomponents may define the means for generating a conditional handover configuration information for the first UE based in part on identifying the one or more candidate target base stations.

In some aspects, the method 1000 may also include configuring, at the source base station, an intra conditional handover preparation for the first UE, wherein the intra conditional handover preparation includes identifying one or more intra candidate relay UEs for the first UE that are in coverage area of the source base station.

At block 1020, the method 1000 may include transmitting the conditional handover configuration information to the first UE. Aspects of block 1020 may be performed by the transceiver 90:5 that receives signals detected on one or more antennas 965 as described with reference to FIG. 9. The detected signals are filtered through the RF front end 988 of the base station 102 and forwarded to the modem 914 to be processed by the handover component 950. Thus, one or more antennas 965, transceiver 902, handover component 950, modem 914, processor 912, and/or the base station 102 or one of its subcomponents may define the means for transmitting the conditional handover configuration information to the first UE.

In some examples, the method may further include receiving an indication from the first UE identifying a selected relay UE from the plurality of relay UEs that were prepared for the first UE and identified in the conditional handover configuration information, and releasing a first UE context from a non-selected plurality of relay UEs.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples,” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems are also presented with reference to various apparatus and methods. These apparatus and methods are described in the detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout the disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

It should be noted that the techniques described herein may be used for various wireless communication networks such as CDMA, TDMA, FDMA, OFDMA, SC-EDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 902.11 (Wi-Fi), IEEE 902.16 (WiMAX), IEEE 90:2,20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A and/or 5G New Radio (NR) system for purposes of example, and LIE or 5G NR terminology is used in much of the description below, although the techniques are applicable beyond LTE/LTE-A and 5G NR applications, e.g., to other next generation communication systems).

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method for wireless communications, comprising:
receiving, at a first user equipment (UE), conditional handover configuration information from a source base station, wherein the conditional handover configuration information in part includes conditional handover execution criteria that should be met by the first UE in order to execute conditional handover;
determining, at the first UE, that that the conditional handover execution criteria are satisfied based in part on one of channel conditions between the first UE and the source base station falling below a channel condition threshold or a sidelink channel condition between the first UE and a second UE falling below a sidelink channel condition threshold; and
triggering the conditional handover at the first UE to transition communication from the source base station to a target base station either via direct communication path or a relay path.

2. The method of claim 1, wherein the first UE is in communication with the source base station via the direct communication path prior to triggering the conditional handover, and
wherein the conditional handover configuration information includes information regarding a plurality of candidate relay UEs prepared by the target base station for the first UE to select from for the relay path to the target base station.

3. The method of claim 2, further comprising:
selecting a relay UE from the plurality of candidate relay UEs prepared by the target base station for the first UE based in part on measurement of sidelink discovery reference signals received power (SD-RSRP) between the first UE and each of the plurality of candidate relay UEs.

4. The method of claim 1, wherein the first UE is in communication with the source base station via the relay path prior to triggering the conditional handover.

5. The method of claim 4, wherein determining that that the conditional handover execution criteria are satisfied, comprises:
measuring sidelink reference signals received power (SL-RSRP) between the first UE and the second UE; and
determining that the SL-RSRP falls below the sidelink channel condition threshold.

6. The method of claim 1, wherein triggering the conditional handover at the first UE to transition the communication from the source base station to the target base station, comprises:
maintaining communication with the source base station while a target path to the target base station is setup via either the direct communication path or the relay path.

7. The method of claim 1, wherein the first UE is a relay UE for one or more remote UEs to communicate with the source base station prior to triggering the conditional handover.

8. The method of claim 7, wherein triggering the conditional handover at the first UE to transition the communication from the source base station to the target base station, comprises:
receiving, at the first UE, a remote UE handover command from the source base station as part of the conditional handover configuration information; and
transmitting the remote UE handover command from the first UE to the one or more remote UEs upon triggering the conditional handover, wherein the one or more remote UEs reconfigure connection to the target base station via the first UE.

9. An apparatus for wireless communications, comprising:
at least one processor; and
a memory coupled to the at least one processor, the memory including instructions executable by the at least one processor to cause the apparatus to:
receive, at a first user equipment (UE), a conditional handover configuration information from a source base station, wherein the conditional handover configuration information in part includes conditional handover execution criteria that should be met by the first UE in order to execute conditional handover;
determine, at the first UE, that that the conditional handover execution criteria are satisfied based in part on one of channel conditions between the first UE and the source base station falling below a channel condition threshold or a sidelink channel condition between the first UE and a second UE falling below a sidelink channel condition threshold; and
trigger the conditional handover at the first UE to transition communication from the source base station to a target base station either via direct communication path or a relay path.

10. (canceled)

11. (canceled)

12. (canceled)

13. (canceled)

14. (canceled)

15. A method for wireless communications, comprising:
receiving, at a source base station, a measurement report from a first user equipment (UE), wherein the measurement report indicates signal quality between the first UE and the source base station;
identifying one or more candidate target base stations for the first UE to transition communication towards from the source base station, wherein the one or more candidate target base stations prepare a plurality of relay UEs for the first UE that are in a coverage area of the one or more candidate target base stations;
generating a conditional handover configuration information for the first UE based in part on identifying the one or more candidate target base stations, wherein the conditional handover configuration information in part includes conditional handover execution criteria that should be met by the first UE in order to execute conditional handover; and
transmitting the conditional handover configuration information to the first UE.

16. The method of claim 15, further comprising:
configuring, at the source base station, an intra conditional handover preparation for the first UE, wherein the intra conditional handover preparation includes identifying one or more intra candidate relay UEs for the first UE that are in coverage area of the source base station.

17. The method of claim 15, further comprising:
maintaining communication between the first UE and the source base station after the first UE initiates conditional handover, wherein the communication between the first UE and the source base station is maintained while a target path from the first UE to the target base station is setup via either a direct communication path or a relay path.

18. The method of claim 15, wherein the one or more candidate target base stations further prepare conditional handover cells for one or more remote UEs that are in communication with the first UE.

19. The method of claim 15, further comprising:
receiving an indication from the first UE identifying a selected relay UE from the plurality of relay UEs that were prepared for the first UE and identified in the conditional handover configuration information; and
releasing a first UE context from a non-selected plurality of relay UEs.

20. The method of claim 15, wherein the conditional handover configuration information further includes a remote UE handover command for the first UE to forward to one or more remote UEs when triggering conditional handover.

21. An apparatus for wireless communications, comprising:
at least one processor; and
a memory coupled to the at least one processor, the memory including instructions executable by the at least one processor to cause the apparatus to:
receive, at a source base station, a measurement report from a first user equipment (UE), wherein the measurement report indicates signal quality between the first UE and the source base station;
identify one or more candidate target base stations for the first UE to transition communication towards from the source base station, wherein the one or more candidate target base stations prepare a plurality of relay UEs for the first UE that are in a coverage area of the one or more candidate target base stations;
generate a conditional handover configuration information for the first UE based in part on identifying the one or more candidate target base stations, wherein the conditional handover configuration information in part includes conditional handover execution criteria that should be met by the first UE in order to execute conditional handover; and
transmit the conditional handover configuration information to the first UE.

22. (canceled)

23. (canceled)

24. (canceled)

25. (canceled)

26. (canceled)

27. The apparatus of claim 9, wherein the first UE is in communication with the source base station via the direct communication path prior to triggering the conditional handover, and
wherein the conditional handover configuration information includes information regarding a plurality of candidate relay UEs prepared by the target base station for the first UE to select from for the relay path to the target base station.

28. The apparatus of claim 27, wherein the instructions are further executable by the at least one processor to:
select a relay UE from the plurality of candidate relay UEs prepared by the target base station for the first UE based in part on measurement of sidelink discovery reference signals received power (SD-RSRP) between the first UE and each of the plurality of candidate relay UEs.

29. The apparatus of claim 9, wherein the first UE is in communication with the source base station via the relay path prior to triggering the conditional handover.

30. The apparatus of claim 9, wherein the instructions to determine that that the conditional handover execution criteria are satisfied are further executable by the at least one processor to:
measure sidelink reference signals received power (SL-RSRP) between the first UE and the second UE; and
determine that the SL-RSRP falls below the sidelink channel condition threshold.

31. The apparatus of claim 9, wherein the instructions to trigger the conditional handover at the first UE to transition the communication from the source base station to the target base station are further executable by the at least one processor to:
maintain communication with the source base station while a target path to the target base station is setup via either the direct communication path or the relay path.

32. The apparatus of claim 9, wherein the first UE is a relay UE for one or more remote UEs to communicate with the source base station prior to triggering the conditional handover.

33. The apparatus of claim 32, wherein the instructions to trigger the conditional handover at the first UE to transition the communication from the source base station to the target base station, are further executable by the at least one processor to:
receive, at the first UE, a remote UE handover command from the source base station as part of the conditional handover configuration information; and
transmit the remote UE handover command from the first UE to the one or more remote UEs upon triggering the conditional handover, wherein the one or more remote UEs reconfigure connection to the target base station via the first UE.

34. The apparatus of claim 21, wherein the instructions are further executable by the at least one processor to:
configure, at the source base station, an intra conditional handover preparation for the first UE, wherein the intra conditional handover preparation includes identifying one or more intra candidate relay UEs for the first UE that are in coverage area of the source base station.

35. The apparatus of claim 21, wherein the instructions are further executable by the at least one processor to:
maintain communication between the first UE and the source base station after the first UE initiates conditional handover, wherein the communication between the first UE and the source base station is maintained while a target path from the first UE to the target base station is setup via either a direct communication path or a relay path.

36. The apparatus of claim 21, wherein the one or more candidate target base stations further prepare conditional handover cells for one or more remote UEs that are in communication with the first UE.

37. The apparatus of claim 21, wherein the instructions are further executable by the at least one processor to:
receive an indication from the first UE identifying a selected relay UE from the plurality of relay UEs that were prepared for the first UE and identified in the conditional handover configuration information; and
release a first UE context from a non-selected plurality of relay UEs.

38. The apparatus of claim 21, wherein the conditional handover configuration information further includes a remote UE handover command for the first UE to forward to one or more remote UEs when triggering conditional handover.
